(19) United States
(12) Patent Application Publication
(10) Pub. No.: US 2022/0405573 A1
(43) Pub. Date: Dec. 22, 2022

(54) CALIBRATION FOR A DISTRIBUTED SYSTEM

(71) Applicant: Ford Global Technologies, LLC, Dearborn, MI (US)

(72) Inventors: Sandhya Bhaskar, Blacksburg, VA (US); Shreyasha Paudel, Sunnyvale, CA (US); Nikita Jaipuria, Union City, CA (US); Jinesh Jain, Pacifica, CA (US)

(73) Assignee: Ford Global Technologies, LLC, Dearborn, MI (US)

(21) Appl. No.: 17/351,404

(22) Filed: Jun. 18, 2021

(51) Int. Cl. G06N 3/08; G06N 3/04; H04L 29/08

(52) U.S. Cl. CPC G06N 3/08; G06N 3/0481; H04L 67/34; H04L 67/10

(57) ABSTRACT

A first computer can operate a first instance of a neural network, receive a first data set input to the first instance of the neural network, determine a first calibration parameter for the neural network in the first instance of the neural network based on the first data set, and send the first calibration parameter to a server computer. A second computer can operate a second instance of the neural network, receive a second data set input to the second instance of the neural network, determine a second calibration parameter for the neural network in the second instance of the neural network based on the second data set, and send the second calibration parameter to the server computer. A server computer can aggregate the first and second calibration parameters to update a model of the neural network and update the neural network model for the first and second instances of the neural network at the first and second computers based on the aggregated first and second calibration parameters.

### BACKGROUND

A trained neural network may be used to perform control operations of a machine, object detection, audio processing, etc. A neural network may be deployed in multiple computers interconnected via wired and/or wireless communications. The computers may receive data, e.g., from a sensor, an input device, etc., and input the received data to the neural network, and operate the computer-based on an output of the neural network. Performance of the neural network in each of the computers may in part be based on the received input data and the training data used to train the neural network.

### BRIEF DESCRIPTION OF THE DRAWINGS

FIG. 1 is a block diagram showing an example system vehicle including multiple vehicles each including an instance of a neural network.

FIG. 2 is a block diagram illustrating example components of the vehicles of FIG. 1.

FIG. 3 illustrates a process for determining a calibration parameter in respective computer nodes of the example federated system of FIG. 1.

FIG. 4 is a block diagram illustrating an example of calibrating a neural network.

FIG. 5 is a flowchart of an example process for operating a server computer of the system of FIG. 1.

FIG. 6 is a flowchart of an example process for operating computers of the vehicles of FIG. 1.

### DETAILED DESCRIPTION

### Introduction

Disclosed herein is a system for calibrating a neural network model in a federated system, including a first computer that is programmed to operate a first instance of a neural network, to receive a first data set input to the first instance of the neural network, to determine a first calibration parameter for the neural network in the first instance of the neural network based on the first data set, and to send the first calibration parameter to a server computer, a second computer that is programmed to operate a second instance of the neural network, to receive a second data set input to the second instance of the neural network, to determine a second calibration parameter for the neural network in the second instance of the neural network based on the second data set, and to send the second calibration parameter to the server computer. The server computer is programmed to aggregate the first and second calibration parameters to update a model of the neural network, and to update the neural network model for the first and second instances of the neural network at the first and second computers based on the aggregated first and second calibration parameters.

The server computer may be further programmed to aggregate the first and second calibration parameters by determining an aggregated calibration value to apply to an output of the model of the neural network.

The server computer may be further programmed to receive a third calibration parameter from the first computer and a fourth calibration parameter from the second computer; and to adjust the aggregated calibration value based on the third and fourth calibration parameters, thereby determining an updated aggregated calibration value.

The server computer may be further programmed to determine the aggregated calibration value by calculating an average of the first and second calibration parameters.

The first computer may be in a first vehicle and the second computer may be in a second vehicle.

The first computer may be programmed to periodically send updated calibration parameters from the first computer to the server computer, and the second computer may be further programmed to periodically send updated calibration parameters from the second computer to the server computer and the server computer is further programmed, upon receiving the updated calibration parameters, to transmit updated aggregated calibration parameters to the first and second computers.

The neural network may be configured to operate lighting, entertainment, seat adjustment, driver assistance function, or collision avoidance of a vehicle.

The first data set and the second data set may include (i) sensor data including data specifying a driver behavior, (ii) exterior data including image data, environmental data.

The server computer may be programmed to select the first computer and the second computer based on one or more of (i) a deployment geographical region of the first and second computers, (ii) a user group data, (iii) stored data specifying that data collection from the first and second computers is activated.

Further disclosed herein is a method for calibrating a neural network model in a federated system, including operating a first instance of a neural network at a first computer, receiving, at the first computer, a first data set input to the first instance of the neural network, determining a first calibration parameter for the neural network in the first instance of the neural network based on the first data set, operating a second instance of the neural network at a second computer, determining a second calibration parameter for the neural network in the second instance of the neural network based on the first data set, sending the first calibration parameter and the second calibration parameter to a server computer, then, in the server computer, aggregating the first and second calibration parameters to update a model of the neural network; and providing the updated neural network model to the first computer and the second computer.

Aggregating the first and second calibration parameters may include determining an aggregated calibration value to apply to an output of the model of the neural network.

The method may further include receiving, in the server computer, a third calibration parameter from the first computer and a fourth calibration parameter from the second computer; and adjusting the aggregated calibration value based on the third and fourth calibration parameters, thereby determining an updated aggregated calibration value.

The method may further include determining the aggregated calibration value by calculating an average of the first and second calibration parameters.

The method may further include determining the first and second calibration parameters using a temperature scaling technique.

The method may further include a normalization technique, including one of softmax and sigmoid, as a last stage activation function of the neural network.

The first computer may be in a first vehicle and the second computer may be in a second vehicle.

The method may further include periodically sending updated calibration parameters from the first and second computers to the server computer, and upon receiving the updated calibration parameters, sending, from the server computer, updated aggregated calibration parameters to the first and second computers.

The neural network may be configured to operate lighting, entertainment, seat adjustment, driver assistance function, or collision avoidance of a vehicle.

The first data set and the second data set may include (i) sensor data including data specifying a driver behavior, (ii) exterior data including image data, environmental data.

The method may further include selecting the first and second computer based on one or more of (i) a deployment geographical region of the first and second computers, (ii) a user group data, (iii) stored data specifying that data collection from the first and second computers is activated.

Further disclosed is a computing device programmed to execute any of the above method steps.

Yet further disclosed is a computer program product, comprising a computer-readable medium storing instructions executable by a computer processor, to execute any of the above method steps.

### System Elements

A computer such as a computer in a vehicle, a robot, a manufacturing controller, a drone, etc., is typically programmed to receive sensor data, e.g., image data, audio data, data specifying a driver behavior, environmental data, etc., and output object detection data, i.e., a classification or identification of an object based on the input data. To process the input data, the computer may include various types of programming such as a neural network that is configured to receive the input data and then output data based on the received input data. In the present document, a neural network is a software program that accepts input data, and outputs some determination(s) about the input data, e.g., a classification or identification of an object. A neural network can be specified according to a model that includes multiple layers of nodes (or artificial neurons). The model typically specifies weight for respective connection between nodes (or neurons). A positive weight represents an excitatory connection, while negative weight values represent inhibitory connections. Thus, all inputs to a node can be modified by (e.g., multiplied by) a weight, and then the modified inputs can be summed to provide an input to a node. For example, a neural network may be trained with training data to detect an object, e.g., an obstacle, a human, an animal, etc., in received image data from a camera sensor(s). Training data means input data including ground truth data, e.g., image data in which an object or a human is labeled to train the neural network.

Performance of a neural network in detecting an object is at least in part related to training data used to train the respective neural network for that specific type of object. Exposure to new data, e.g., object shapes not previously used to train an object detection neural network, may lead to miscalibration and hence poor performance in a neural network. Performance of a neural network, in the present context, measures the ability of the neural network in providing an expected operation, e.g., performance can be measured by a rate of detecting an object for an object detection neural network, a rate of correctly recognizing words in a speech-recognition neural network, etc. For example, training a pedestrian detection neural network with training data lacking images of a fire hydrant may result in misdetection or failure of detection of a fire hydrant when the neural network is deployed in a computer, e.g., in a vehicle computer.

Neural networks may be trained with new data during operation in a computer. For example, a neural network deployed in a first vehicle may improve its operation based on sensor data received from first vehicle sensors, e.g., various types of other vehicles with shapes and dimensions not included in the training data used to train the neural network prior to deploying to the vehicle computers. However, the neural network operating in a second vehicle may lack access to similar sensor data, e.g., because of operation in another region, and thus cannot improve its operation to detect those shapes and sizes not included in the training data used to train the neural network prior to deployment to the second vehicle computer.

Calibration of a neural network in a federated system can include a first computer programmed to operate a first instance of a neural network, to receive a first data set input to the first instance of the neural network, to determine a first calibration parameter for the neural network in the first instance of the neural network based on the first data set, and to send the first calibration parameter to a server computer. A second computer in the system may be programmed to operate a second instance of the neural network, to receive a second data set input to the second instance of the neural network, to determine a second calibration parameter for the neural network in the second instance of the neural network based on the second data set, and to send the second calibration parameter to the server computer. A server computer in the system can be programmed to aggregate the first and second calibration parameters to update the neural network, and to update the neural network for the first and second instances of the neural network at the first and second computers based on the aggregated first and second calibration parameters.

Thus, advantageously, by sending updated neural network model data to the first and second computers, the first and second computers can be provided with the updated model. Additionally, the disclosed solution may be advantageous with respect to data management and control. As discussed above, the data received from sensors and/or other devices at each of the first and second computers is used to determine first and second calibration parameters, and then the first and second calibration parameters are sent to the server computer; thus, the server computer may lack access to the collected sensor data, etc., from each of the first and second computers, lessening opportunities for introducing errors and/or misappropriating data.

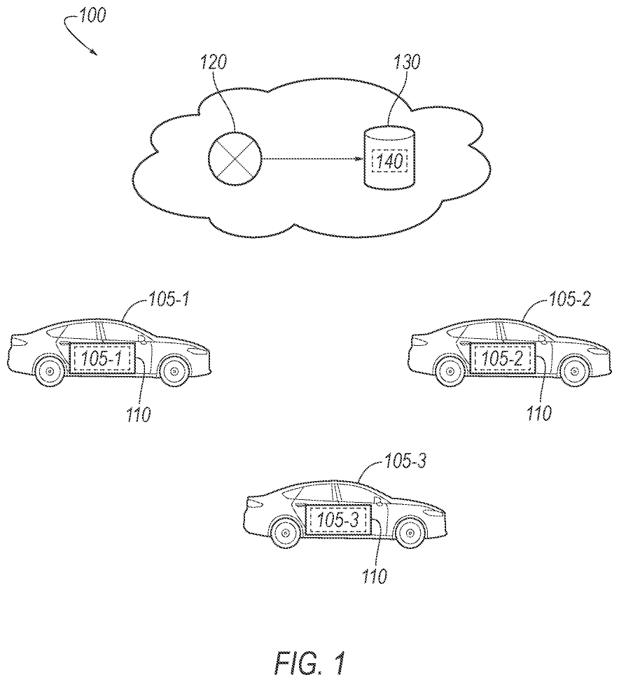

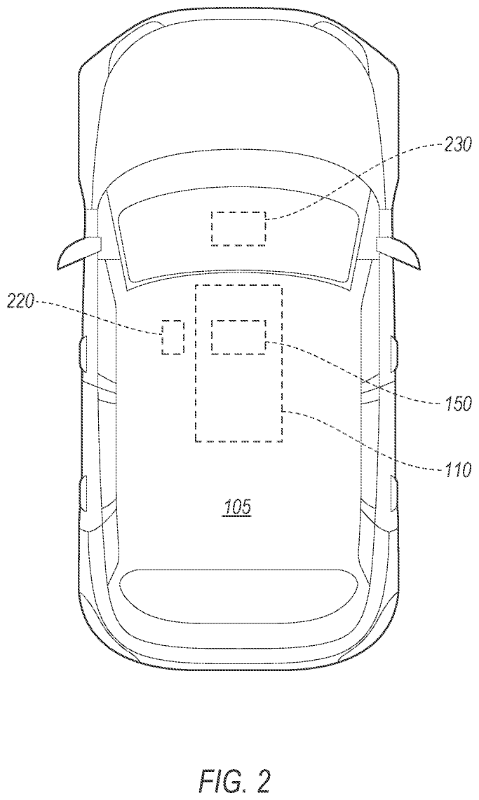

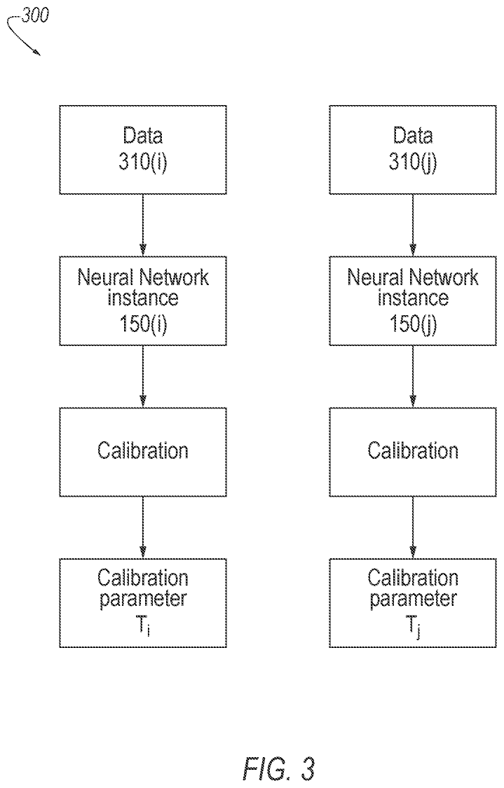

With reference to FIGS. 1-3, an example federated system 100 for calibrating a neural network. As discussed below, the federated system 100 includes an architecture that allows interoperability and information sharing between semi-autonomous de-centrally organized (i.e., distributed) nodes, e.g., computers 110. FIG. 1 is a block diagram of an example federated system including a server computer 130 with a neural network 140 and multiple vehicles 105. A computer in each vehicle 105-1, 105-2, 105-3 includes having an instance 150-1, 150-2, 150-3 of the neural network 140. FIG. 2 shows a block diagram of an example vehicle 105. FIG. 3 illustrates a process 300 for calibrating an instance 150 of the neural network 140 in a vehicle 105 computer 110.

With reference to FIGS. 1-3, an example federated system 100 may include vehicle 105 computers 110, a neural network aggregator 120, and a server computer 130. A neural network 140 stored in the server computer 130 and deployed as instances 150 to computers 110 may be trained to operate lighting, entertainment, seat adjustment, driver assistance functions, and/or collision avoidance features of vehicle(s) 105. Although FIG. 1 shows only three vehicles 105 including the computers 110, the system 100 typically includes a large number, e.g., thousands, of computers 110.

Although the system 100 is discussed and illustrated according to an example that includes updating a computer 110 in a vehicle 105, the system 100 could be implemented in a variety of contexts, i.e., additionally or alternatively, a system 100 could include one or more computers 110 in a variety of different devices, machines, or architectures, e.g., a computer 110 could be included in a mobile robot, an aerial drone, internet of things (IoT) device, etc., configured to communicate via a wired and/or wireless communication network with the server computer 130.

A federated system 100 includes a plurality of computing nodes, e.g., computers 110, which can communicate with one another via a wired and/or wireless computer network and may be geographically decentralized. Computers 110 of the system 100 operate independently from one another, e.g., each having an instance 150 of a neural network 140 received from the server computer 130. For example, in a federated system 100 of vehicles 105, instances 150 of a neural network available locally in the vehicle 105 computers 110 are periodically updated to learn and improve their knowledge base, using incremental improvement techniques. An instance 150 of a neural network 140, in the present context, includes model data in a computer 110 describing the neural network m. Model data in this context is a partial or full copy of a version of the neural network 140 stored in the server computer 130. For example, the server computer 130 may store a newest version of a neural network 140, whereas an instance 150 of the neural network 140 could include data from that newest version of from an older or different version of the neural network 140. Thus, the computer 110 executes blocks of a local copy of the neural network, i.e., an instance 150, received from the server computer 130. An instance 150 includes a version of the neural network 140 model, e.g., includes data specifying layers, nodes, weights, etc., of the neural network 140.

FIG. 2 illustrates an example host vehicle 105 including the computer 110, actuator(s) 220, and sensor(s) 230. A vehicle 105 may be powered in a variety of known ways, e.g., with an electric motor and/or internal combustion engine. A vehicle 105 may communicate via vehicle to infrastructure (V2X) communications with one or more remote computers such as the server computer 130.

The computer 110 includes a processor and a memory such as are known. The memory includes one or more forms of computer-readable media, and stores instructions executable by the computer 110 for performing various operations, including as disclosed herein.

The computer 110 may operate the vehicle 105 in an autonomous or semi-autonomous mode. For purposes of this disclosure, an autonomous mode is defined as one in which each of vehicle 105 propulsion, braking, and steering are controlled by the computer 110; in a semi-autonomous mode the computer 110 controls one or two of vehicle 105 propulsion, braking, and steering.

The computer 110 may include programming to operate one or more of vehicle brakes, propulsion (e.g., control of acceleration in the vehicle by controlling one or more of an internal combustion engine, electric motor, hybrid engine, etc.), steering, climate control, interior and/or exterior lights, etc., as well as to determine whether and when the computer 110, as opposed to a human operator, is to control such operations.

The computer 110 may include or be communicatively coupled to, e.g., via a vehicle communications bus as described further below, more than one processor, e.g., controllers or the like included in the vehicle for monitoring and/or controlling various vehicle controllers, e.g., a powertrain controller, a brake controller, a steering controller, etc. The computer 110 is generally arranged for communications on a vehicle communication network such as a bus in the vehicle such as a controller area network (CAN) or the like.

Via the vehicle network, the computer 110 may transmit messages to various devices in the vehicle and/or receive messages from the various devices, e.g., the sensors 230, actuators 220, etc. Alternatively or additionally, in cases where the computer 110 comprises multiple devices, the vehicle communication network may be used for communications between devices represented as the computer 110 in this disclosure. Further, as mentioned below, various controllers and/or sensors may provide data to the computer 110 via the vehicle communication network.

The actuators 220 may be implemented via circuits, chips, or other electronic components that can actuate various vehicle subsystems in accordance with appropriate control signals as is known. The actuators 220 may be used to control braking, acceleration, and steering of the vehicle 105. As an example, the vehicle 105 computer 110 may output control instructions to control the actuators 220.

Vehicle 105 sensors 230 may provide data encompassing at least some of an exterior of the vehicle 105, e.g., a GPS (Global Positioning System) sensor, camera, radar, and/or lidar (light imaging detection and ranging). For example, a camera sensor 230, e.g., mounted to a front windshield of the vehicle 105, may provide object detection, i.e., data including dimensions and/or relative location of objects outside the vehicle 105 within a field of view of the sensor(s) 230, e.g., with respect to two or three axes of a three-dimensional Cartesian coordinate system (e.g., specified by geo-coordinates and/or other x, y, z coordinates).

The server computer 130 includes a processor programmed to perform steps disclosed herein including but not limited to updating one or more neural network models, receiving data from the computers 110 and sending updates regarding the neural networks to the computers 110.

The aggregator 120 is a computer program including instructions for aggregating received calibration parameters from the computers 110, as discussed below. In the context of the present document, “aggregating” two or more parameters means, and the aggregator 120 includes instructions for, calculating a value based on the input parameters using a statistical technique such as determining a median or average, etc., and/or any another mathematical operation. Equation (1) shows an example operation agr to calculate an aggregated calibration parameter Tₐ based on received calibration parameter Tᵢ from n computers 110. Aggregating the first and second calibration parameters includes determining an aggregated calibration value Tₐ to apply to an output of the neural network 140. Although shown as a separate block in the example system 100 of FIG. 1, the aggregator 120 may be stored in a memory of the server computer 130 and a processor of the server computer 130 may be programmed to execute the aggregator 120. Additionally or alternatively, a remote computer may be programmed to execute the aggregator 120 program and be communicatively connected to the server computer 130.

Tₐ=agr(Tᵢ) {i=1 . . . n} (1)

The server computer 130 may communicate via a wired or wireless communication network with the computers 110. For example, the server computer 130 may communicate via wireless V2X (vehicle to infrastructure) communications with vehicles 105. In another example, the server computer 130 may communicate via wired internet communication with computers 110 in IoT devices installed in buildings.

With reference to FIGS. 1 and 3, the server computer 130 can be programmed to send the instances 150-1, 150-2, 150-3 of neural network 140, e.g., via wired or wireless communications, to the computers 110. As discussed above, a neural network 140 is specified by a model that includes data specifying layers, nodes, weights, etc.

The plurality of computers 110, e.g., a first and second computer 110, can be programmed to operate instances 150-1, 150-2, of the neural network 140 in each of the respective computers 110. For example, the neural network 140 may be trained to detect human and/or animal objects within a field of view of the vehicle 105 camera sensor 230.

With reference to FIGS. 1 and 3, the first computer 110 can be programmed to receive a first data set 310(i) from the first vehicle 105 sensor(s) 230, devices, etc., and to input the received first data set 310-1, e.g., image data, to the first instance 150-1 of the neural network 140. The second computer 110 can be programmed to receive a second data set 310-2 from the second vehicle 105 sensor(s) 230, devices, etc., and to input the received second data set 310-2, e.g., image data, to the second instance 150-2 of the neural network 140.

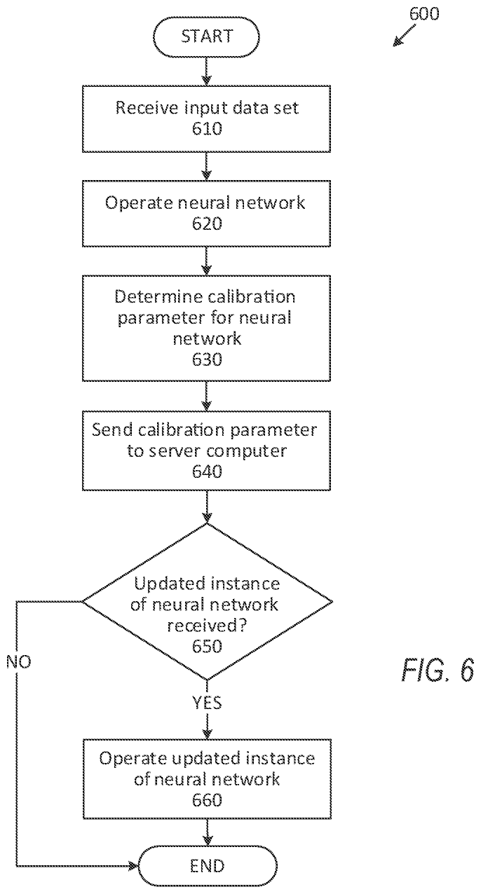

With reference to FIG. 3, the process 300 can be performed in each of the computers 110, as discussed further below with reference to the block 630 of FIG. 6. The process 300 represents a calibration process performed in an i^{th} computer 110. With continued reference to FIGS. 1-3, each of the two or more computers 110 of the federsated system 100, e.g., each computer 110 in an i^{th} vehicle 105 can determine a calibration parameter Tᵢ for the neural network 140 in that vehicle 105 using a calibration process such as Temperature Scaling, as discussed below. Typically a federated system 100 includes a large number of computers 110. However, for simplicity here below this technique is discussed with respect to two computers 110. Each of the first and second computers 110 can be programmed to determine a first and a second calibration parameter T₁, T₂ for the neural network 140. Determining the first and second calibration parameters T₁, T₂ is performed locally in a computer 110 based on the locally available instance 150, of the neural network 140 and the locally collected first and second data sets 310-1, 310-2. In the context of this document, a calibration parameter Tᵢ is value assigned to a neural network instance 150-i, e.g., in an i^{th} vehicle 105 that is applied to (e.g., as a multiplier) output of the neural network instance 150 to adjust up or adjust down the neural network instance's output probability estimates such that they align with a performance of an underlying neural network 140. For example, when Temperature Scaling technique is used for calibration, a temperature parameter Tᵢ is a hyperparameter used to control a randomness of predictions by scaling the logits before applying a softmax operation (explained further below). A hyperparameter is a value supplied to a neural network model, whereas a parameter of a neural network is learned by the machine, e.g., weights and biases. Thus, a calibration parameter T₁, T₂ is typically applied prior to providing output of the neural network 140 to, e.g., a vehicle 105 navigation algorithm. For example, the calibration parameter T₁, T₂ may adjust up or down a confidence level output of the neural network. A confidence level provides a likelihood that a determination of the neural network is accurate, e.g., a neural network 140 may detect an animal on a road and specify a confidence level of 80%. A calibration parameter T₁, T₂ may adjust up or down the determined confidence level. Additionally or alternatively, calibrating a neural network 140 can include modifying weights in the neural network 140. Calibrating trained neural networks 140 can improve a reliability of an output of the neural network 140, thus improving the performance of the neural network 140, e.g., in identifying a type of an object. The calibration parameter T is included in the neural network 140. Thus, sending an instance 150 of the neural network 140 to computers 110 includes data specifying the calibration parameter T.

In one example, the computer 110 may be programmed to send a computer 110 location, e.g., vehicle 105 GPS (global positioning system) coordinates, to the server computer 130. The server computer 130 may be programmed to identify a calibration parameter T associated with a vehicle 105 as an outlier, e.g., using statistical methods such as deviation, and to determine a geographical area of the respective computer 110 as a “hotspot.” A geographical area, in the context of the present document, is an area including the computer 110 location, e.g., an area with a radius of 5 kilometers around the computer 110 location, a city, a state, a neighborhood, etc. In the present context, a hotspot is a geographical area for which the server computer 130 handles the received calibration parameters T differently with respect to aggregation. For example, the server computer 130 may be programmed to ignore the received calibration parameters T received from a hotspot, aggregate them with a different weight, e.g., scale down an effect of the received calibration parameter T from the hotspot, etc.

There are various techniques for calibrating a neural network 140, e.g., a temperature scaling technique. Temperature Scaling (TS) uses a single temperature parameter T to support detecting and/or reducing miscalibration in a neural network 140 that use image data as input. This results in over-confident neural networks with unreliable and misleading output probability estimations. Both the neural network 140 architecture as well as the training dataset used for training, determine a degree of miscalibration in a neural network 140. Miscalibration, in the present context, means that there is a deviation of determined output score from an expected output score that is equivalent to or represents the true statistical performance of the underlying neural network (e.g.: accuracy in classification tasks). True statistical performance in this context is the performance of the given/underlying neural network model, gauged using the ground truth dataset that is already available in the form of the training dataset or validation dataset. For example, in classification specific tasks, accuracy is used as a common performance metric that refers to the number of samples correctly classified, among the total number of samples available. When miscalibration is high, the output scores are higher/lower than the true performance of the neural network. The resulting over-confident or under-confident models can be misleading and less reliable.

As discussed below, the first and second calibration parameters T₁, T₂ can be aggregated to update the neural network 140, thereby generating an updated neural network model 140 including an aggregated calibration parameter Tₐ. The server computer 130 can be programmed to execute the aggregator program 120. Alternatively, a remote computer may be programmed to execute an aggregator program 120.

The server computer 130 can be programmed to provide updated instances 150-1, 150-2 of the updated neural network model 140 to the first computer 110 and the second computer 110. In one example, the server computer 130 may be programmed to send an aggregated calibration parameter, e.g., an aggregated temperature parameter Tₐ, to the first and second computers 110. The computers 110 may be programmed to apply the aggregated calibration parameter Tₐ to the output of the local instance of the neural network 140. Thus, in some examples, it can be sufficient to send the aggregated calibration parameter Tₐ to the computers 110, because there may be no change in the weights and nodes of the neural network 140. In some other examples, updating neural network model instances 150-1, 150-2 may include updating other data such as weights, nodes, etc., of the neural network 140.

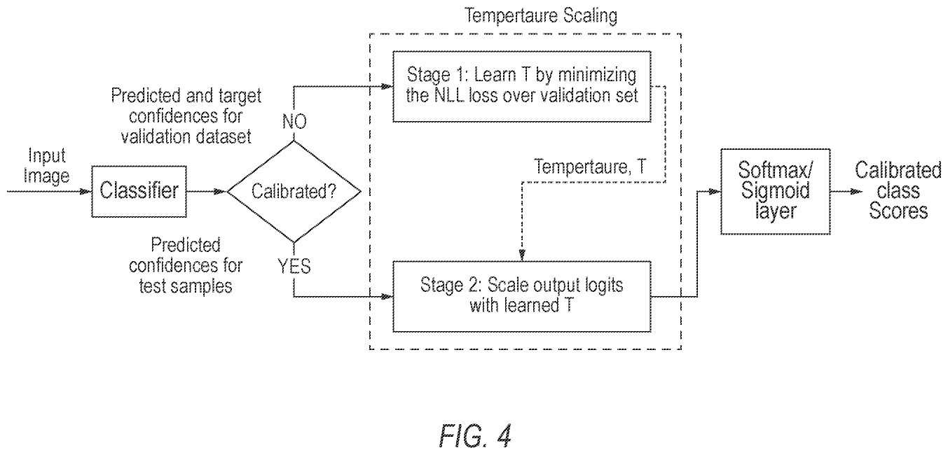

FIG. 4 illustrates how Temperature Scaling technique can be used in a classification task of, e.g., an object detector neural network 140, that takes images as input. As illustrated in FIG. 4, a calibration pipeline (process) typically encompasses two stages. To begin with, a verification is conducted to determine whether the neural network 140 used for classification (i.e., determining a class such as human, object, animal, etc.) was previously calibrated. This can be done by verifying if the classifier, e.g., object detection neural network 140, has a previously stored calibration parameter (e.g., temperature) T. If the neural network 140 is uncalibrated, in a first step, the validation dataset is used to minimize a negative log-likelihood loss (NLL-loss) to learn the temperature parameter T.

Once the neural network 140 is calibrated in the first step or if the neural network 140 is verified to be previously calibrated, then the associated temperature parameter T is used to adjust the output logits before passing them to a normalization stage using a normalization technique, e.g., sigmoid/softmax stage, as a last stage activation function of the neural network 140 to obtain calibrated (reliable) classification scores. A neural network 140 output is typically a vector known as the logits.

A “sigmoid function” is a mathematical function having a characteristic S-shaped curve or sigmoid curve. A “softmax function” (also known as softargmax or normalized exponential function) is a generalization of a logistic function to multiple dimensions. A logistic function is a common S-shaped (sigmoid) curve. It is often used as a last activation function of a neural network to normalize the output of a network to a probability distribution over predicted output classes, based on Luce's choice axiom.

A logistic model (or logit model) is used to model a probability of a certain class or event existing such as pass/fail, win/lose, alive/dead or healthy/sick.

The computers 110 can be programmed to send respective calibration parameters Tᵢ to the server computer 130, e.g., via a wired communication network, V2X communications, etc.

As discussed above, the aggregator 120, e.g., executed by the server computer 130, determines the aggregated calibration parameter Tₐ based on the received calibration parameters T₁, T₂. In one example, the aggregator 120 may calculate an average of the first and second calibration parameters T₁, T₂. In another example, the aggregator 120 may determine a median or average of calibration parameters received from the plurality of computers 110.

Updating instances 150-1, 150-2 of the neural network 140 may be incremental. For example, the server computer 130 may be programmed to receive a third calibration parameter from the first computer 110 and a fourth calibration parameter from the second computer, and to adjust the aggregated calibration value Tₐ based on the third and fourth calibration parameters, thereby determining an updated aggregated calibration value Tₐ. In some examples, in determining the updated aggregated calibration value Tₐ, a previous value of the aggregated calibration value Tₐ and the recently received third and fourth calibration parameters may be taken into account, e.g., by using a running average technique. Additionally or alternatively, an aggregated calibration value Tₐ can be determined based on the parameters within the neural network 140, e.g., weights. Thus, an aggregation technique can be applied to the weights of the neural network 140 model.

The server computer 130 may be programmed to periodically receive updated calibration parameters Tₓ from the computers 110, to update the aggregated calibration parameter Tₐ based on the received updated calibration parameters Tₓ, to send updated aggregated calibration parameter Tₐ to the computers 110. The computers 110 may be programmed upon receiving the updated aggregated calibration parameter Tₐ from the server computer 130, to operate using the updated aggregated calibration parameter Tₐ.

As discussed above, the federated system 100 includes the plurality of computers 110, e.g., in the vehicles 105. With respect to FIG. 1, the plurality of vehicles 105 may be selected based on one or more of (i) a geographical region in which selected vehicles 105 are commonly deployed, e.g., within vehicles 105 located in a country, a city, etc., (ii) user group data, e.g., age, etc., (iii) stored data specifying that data collection from the first and second computers is activated, e.g., stored privacy settings specify a permission to use the vehicle data for calibration purposes. As discussed above, the system 100 could be implemented in a variety of contexts. In one example, a system 100 may include smartphone devices with stored privacy data specifying a permission to use phone camera image data to improve object detection neural network of the smartphone.

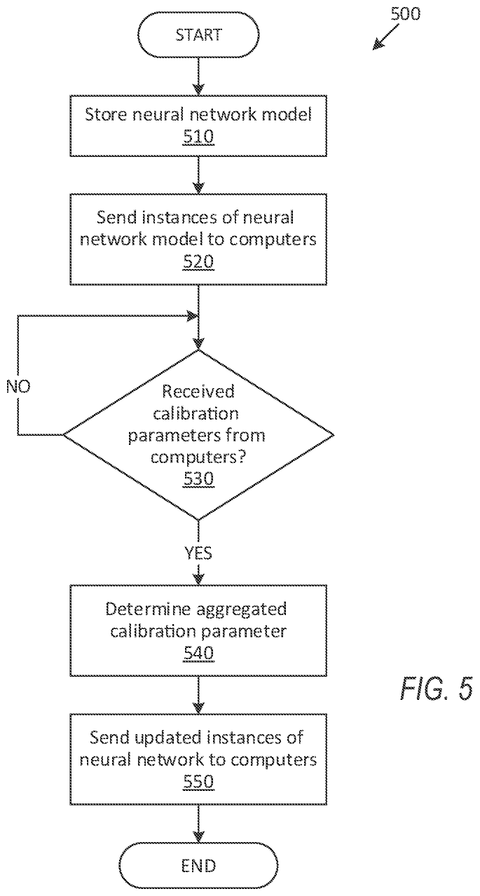

FIG. 5 is a flowchart of an example process 500 for operating the server computer 130. The server computer 130 may be programmed to execute blocks of the process 500.

The process 500 begins in a block 510, in which the computer 130 stores a neural network 140, e.g., in a computer 130 memory. The stored neural network 140 may be trained to perform, e.g., object detection, pedestrian detection, speech recognition, control of a robot, etc.

Next, in a block 520, the server computer 130 sends data including instances 150 of the neural network 140 to a plurality of computers 110, e.g., vehicle 105 computers 110.

Next, in a decision block 530, the server computer 130 determines whether calibration parameters Tₓ are received from the computers 110. For example, with reference to FIG. 1, the computer 130 may be programmed to determine that calibration parameters T₁, T₂, T₃ are received from the vehicle 105 computers 110. In one example, the computer 130 may determine that calibration parameters Tₓ are received upon determining that calibration parameters Tₓ are received from at least a specified percentage, e.g., 70%, of the computers 130 in the system 100. In another example, the computer 130 may determine that calibration parameters Tᵢ are received upon determining that each of the computer s110 has sent a calibration parameter Tᵢ. If the server computer 130 determines that calibration parameters Tᵢ are received from the computers 110, then the process 500 proceeds to a block 540 otherwise the process 500 returns to the decision block 530, or alternatively the process 500 ends, although not shown in FIG. 5.

In the block 540, the server computer 130 determines an aggregated calibration parameter Tₐ based on the received calibration parameters Tᵢ, thereby determining an updated neural network 140. For example, the server computer 130 may be programmed to determine the aggregated calibration parameter Tₐ by calculating an average, median, etc., of the received calibration parameters Tₓ. Additionally or alternatively, as discussed above with reference to FIG. 4, the computer 130 may be programmed to determine the aggregated calibration parameter Tₐ based on the previously determined calibration parameter T and the received calibration parameters Tᵢ. In one example, the previously determined calibration parameter T may be an aggregated calibration parameter Tₐ determined based on previously received calibration parameters Tᵢ, e.g., from some prior time, e.g., an hour earlier.

Next, in the block 550, the server computer 130 sends updated instances 150 of the neural network 140 to the computers 110. For example, the computer 130 may be programmed to send the instances 150-1, 150-2 to the first and second computers 110. In one example, sending an instance 150 of an updated neural network model 140 may include sending the aggregated calibration parameter Tₐ to the computers 110.

Following the block 550, the process 500 ends, or alternatively, returns to the block 510, although not shown in FIG. 5.

FIG. 6 is a flowchart of an example process 600 for operating computers 110 of the vehicles 105 of FIG. 1. In one example, a vehicle 105 computer 110 may be programmed to execute blocks of the process 600. In another example, a computer of a robot, an IoT device, etc., may be programmed to execute blocks of the process 600.

The process 600 begins in a block 610, in which the computer 110 receives input data set 310(i), e.g., from (i) an image sensor such as a camera sensor 230, (ii) an audio sensor 230, (iii) a human-machine interface device such as a touch screen, etc.

Next, in a block 620, the computer 110 operates an instance 150 of a neural network 140 stored locally in the computer 110. The computer 110 may have received the instance 150 of the neural network 140 via wired and/or wireless communications from the server computer 130. The computer 110 may operate the instance 150 of a neural network 140 by inputting the received input data set 310, e.g., sensor 230 data, to the local instance 150 and operating, e.g., the vehicle 105, based on one or more outputs of the instance 150 of a neural network 140. For example, the computer 110 may actuate a vehicle 105 brake actuator 220 upon determining based on an output of the instance 150 of a neural network 140 that a pedestrian is detected on a vehicle 105 path within a predetermined distance, e.g., 50 meters.

Next, in a block 630, the computer 110 determines a calibration parameter Tᵢ for the neural network 140 based on the received data set 310(i) using, e.g., a temperature scaling technique. For example, the first and second computers 110 may determine the calibration parameters T₁, T₂. The computer 110 may be programmed in accordance to the process 300 of FIG. 3 to determine the calibration parameter Tᵢ using a calibration technique.

Next, in a block 640, the computer 110 sends the determined calibration parameter Dᵢ to the server computer 130, e.g., via wired and/or wireless communications. In one example, the computer 110 may be programmed to periodically send an updated calibration parameter Tᵢ to the server computer 130.

Next, in a decision block 650, the computer 110 determines whether an updated instance 150 of the neural network 140 is received from the server computer 130. For example, the computer 110 may receive an aggregated calibration parameter Tₐ from the server computer 130. The computer 110 may replace a locally stored calibration parameter T with the received aggregated calibration parameter Tₐ, thereby storing an updated instance 150 of the neural network 140. If the computer 110 determines that an updated instance 150 of the neural network 140 is received, then the process 600 proceeds to a block 660, otherwise the process 600 ends, or alternatively returns to the block 610, although not shown in FIG. 6.

In the block 660, the computer 110 operates the updated instance 150 of the neural network 140. The computer 110 may replace a locally stored calibration parameter T with the received aggregated calibration parameter Tₐ, thereby operating an updated instance 150 of the neural network 140. Following the block 660, the process 600 ends or alternatively returns to the block 610, although not shown in FIG. 6.

The solution disclosed herein advantageously improves reliability of a neural network model output by efficiently, effectively, and accurately providing propagation of neural network models knowledge across a large number of computers 110 in a geographically distributed system.

Localized and region-specific data may be incorporated during continuous learning, within the local neural network. Thus, propagating them can help obtain region-specific information with reliable estimates. The disclosed technique can be particularly useful in applications that are personalizable and where actions/maneuvers of a user can be used in annotating the newly gathered dataset. Some examples include vehicle 105 cabin configuration (lighting, music, seat adjustment), communication network data study for prognostics, and user behavior based on geographical/regional differences. Additionally, the disclosed technique specifically improves data privacy by not directly transferring the sensor data or user data, and rather transferring the local neural network data such as calibration parameters Tₓ to the server computer 130, where the received data is aggregated to update the neural network.

As used herein, the adverb “substantially” means that a shape, structure, measurement, quantity, time, etc. may deviate from an exactly described geometry, distance, measurement, quantity, time, etc., because of imperfections in materials, machining, manufacturing, transmission of data, computational speed, etc.

“Based on” encompasses “based wholly or partly on.” If, herein, a first thing is described and/or claimed as being “based on” the second thing, then the first thing is derived or calculated from the second thing, and/or output from an algorithm, process, or program function that accepts some or all of the second thing as input and outputs some or all of the first thing.

Computing devices as discussed herein generally each include instructions executable by one or more computing devices such as those identified above, and for carrying out blocks or steps of processes described above. Computer-executable instructions may be compiled or interpreted from computer programs created using a variety of programming languages and/or technologies, including, without limitation, and either alone or in combination, Java™, C, C++, Visual Basic, Java Script, Perl, HTML, etc. In general, a processor (e.g., a microprocessor) receives instructions, e.g., from a memory, a computer-readable medium, etc., and executes these instructions, thereby performing one or more processes, including one or more of the processes described herein. Such instructions and other data may be stored and transmitted using a variety of computer-readable media. A file in the computing device is generally a collection of data stored on a computer readable medium, such as a storage medium, a random-access memory, etc.

A computer-readable medium includes any medium that participates in providing data (e.g., instructions), which may be read by a computer. Such a medium may take many forms, including, but not limited to, non-volatile media, volatile media, etc. Non-volatile media include, for example, optical or magnetic disks and other persistent memory. Volatile media include dynamic random-access memory (DRAM), which typically constitutes a main memory. Common forms of computer-readable media include, for example, a floppy disk, a flexible disk, hard disk, magnetic tape, any other magnetic medium, a CD-ROM, DVD, any other optical medium, punch cards, paper tape, any other physical medium with patterns of holes, a RAM, a PROM, an EPROM, a FLASH-EEPROM, any other memory chip or cartridge, or any other medium from which a computer can read.

With regard to the media, processes, systems, methods, etc. described herein, it should be understood that, although the steps of such processes, etc. have been described as occurring according to a certain ordered sequence, such processes could be practiced with the described steps performed in an order other than the order described herein. It further should be understood that certain steps could be performed simultaneously, that other steps could be added, or that certain steps described herein could be omitted. In other words, the descriptions of systems and/or processes herein are provided for the purpose of illustrating certain embodiments, and should in no way be construed so as to limit the disclosed subject matter.

Accordingly, it is to be understood that the present disclosure, including the above description and the accompanying figures and below claims, is intended to be illustrative and not restrictive. Many embodiments and applications other than the examples provided would be apparent to those of skill in the art upon reading the above description. The scope of the invention should be determined, not with reference to the above description, but should instead be determined with reference to claims appended hereto and/or included in a non-provisional patent application based hereon, along with the full scope of equivalents to which such claims are entitled. It is anticipated and intended that future developments will occur in the arts discussed herein, and that the disclosed systems and methods will be incorporated into such future embodiments. In sum, it should be understood that the disclosed subject matter is capable of modification and variation.

All terms used in the claims are intended to be given their plain and ordinary meanings as understood by those skilled in the art unless an explicit indication to the contrary in made herein. In particular, use of the singular articles such as “a,” “the,” “said,” etc. should be read to recite one or more of the indicated elements unless a claim recites an explicit limitation to the contrary.

1. A system for calibrating a neural network model in a federated system, comprising:
a first computer that is programmed to:
operate a first instance of a neural network;
receive a first data set input to the first instance of the neural network;
determine a first calibration parameter T₁ for the neural network using a temperature scaling technique in the first instance of the neural network based on the first data set; and
send the first calibration parameter T₁ to a server computer;
a second computer that is programmed to:
operate a second instance of the neural network;
receive a second data set input to the second instance of the neural network;
determine a second calibration parameter T₂ for the neural network using the temperature scaling technique in the second instance of the neural network based on the second data set; and
send the second calibration parameter T₂ to the server computer;
wherein the server computer is programmed to:
aggregate the first and second calibration parameters T₁ and T₂ to update a model of the neural network; and
update the neural network model for the first and second instances of the neural network at the first and second computers based on the aggregated first and second calibration parameters T₁ and T₂.

2. The system of claim 1, wherein the server computer is further programmed to aggregate the first and second calibration parameters T₁ and T₂ by determining an aggregated calibration value to apply to an output of the model of the neural network.

3. The system of claim 2, wherein the server computer is further programmed to:
receive a third calibration parameter T₃ from the first computer and a fourth calibration parameter T₄ from the second computer; and
adjust the aggregated calibration value based on the third and fourth calibration parameters T₃ and T₄, thereby determining an updated aggregated calibration value.

4. The system of claim 2, wherein the server computer is further programmed to determine the aggregated calibration value by calculating an average of the first and second calibration parameters T₁ and T₂.

5. The system of claim 1, wherein the first computer is in a first vehicle and the second computer is in a second vehicle.

6. The system of claim 1, wherein the first computer is programmed to periodically send updated calibration parameters from the first computer to the server computer, and the second computer is further programmed to periodically send updated calibration parameters from the second computer to the server computer and the server computer is further programmed, upon receiving the updated calibration parameters, to transmit updated aggregated calibration parameters to the first and second computers.

7. The system of claim 1, wherein the neural network is configured to operate lighting, entertainment, seat adjustment, driver assistance function, or collision avoidance of a vehicle.

8. The system of claim 1, wherein the first data set and the second data set include (i) sensor data including data specifying a driver behavior, (ii) exterior data including image data, environmental data.

9. The system of claim 1, wherein the server computer is programmed to select the first computer and the second computer based on one or more of (i) a deployment geographical region of the first and second computers, (ii) a user group data, (iii) stored data specifying that data collection from the first and second computers is activated.

10. A method for calibrating a neural network model in a federated system, comprising:
operating a first instance of a neural network at a first computer;
receiving, at the first computer, a first data set input to the first instance of the neural network;
determining a first calibration parameter T₁ for the neural network using a temperature scaling technique in the first instance of the neural network based on the first data set;
operating a second instance of the neural network at a second computer;
receiving, at the second computer, a second data set input to the second instance of the neural network;
determining a second calibration parameter T₂ for the neural network using a temperature scaling technique in the second instance of the neural network based on the second data set;
sending the first calibration parameter T₁ and the second calibration parameter T₂ to a server computer;
then, in the server computer, aggregating the first and second calibration parameters T₁ and T₂ to update a model of the neural network; and
providing the updated neural network model to the first computer and the second computer.

11. The method of claim 10, wherein aggregating the first and second calibration parameters T₁ and T₂ includes determining an aggregated calibration value to apply to an output of the model of the neural network.

12. The method of claim 11, further comprising:
receiving, in the server computer, a third calibration parameter T₃ from the first computer and a fourth calibration parameter T₄ from the second computer; and
adjusting the aggregated calibration value based on the third and fourth calibration parameters T₃ and T₄, thereby determining an updated aggregated calibration value.

13. The method of claim 11, further comprising determining the aggregated calibration value by calculating an average of the first and second calibration parameters T₁ and T₂.

14. (canceled)

15. The method of claim 10, further comprising using a normalization technique, including one of softmax and sigmoid, as a last stage activation function of the neural network.

16. The method of claim 10, wherein the first computer is in a first vehicle and the second computer is in a second vehicle.

17. The method of claim 10, further comprising:
periodically sending updated calibration parameters from the first and second computers to the server computer; and
upon receiving the updated calibration parameters, sending, from the server computer, updated aggregated calibration parameters to the first and second computers.

18. The method of claim 10, wherein the neural network is configured to operate lighting, entertainment, seat adjustment, driver assistance function, or collision avoidance of a vehicle.

19. The method of claim 10, wherein the first data set and the second data set include (i) sensor data including data specifying a driver behavior, (ii) exterior data including image data, environmental data.

20. The method of claim 10, further comprising selecting the first and second computer based on one or more of (i) a deployment geographical region of the first and second computers, (ii) a user group data, (iii) stored data specifying that data collection from the first and second computers is activated.
